(19) United States
(12) Patent Application Publication
(10) Pub. No.: US 2004/0123057 A1
(43) Pub. Date: Jun. 24, 2004

(54) Method for backing up data

(76) Inventors: Reinhold Freudenschuss, Augsburg (DE); Jurgen Himml, Graben (DE)

Correspondence Address: LERNER AND GREENBERG, PA, P O BOX 2480, HOLLYWOOD, FL, 33022-2480, US

(21) Appl. No.: 10/731,583

(22) Filed: Dec. 9, 2003

(30) Foreign Application Priority Data
Dec. 9, 2002 (DE) 102 57 444.8

(51) Int. Cl. G06F 12/16

(52) U.S. Cl. 711/162; 713/340

(57) ABSTRACT

A method for backing up data in the working memory of a computer given an interruption of the power supply includes, whenever the computer is switched into a power saving mode, automatically storing data, which is in the working memory, into a non-volatile memory.

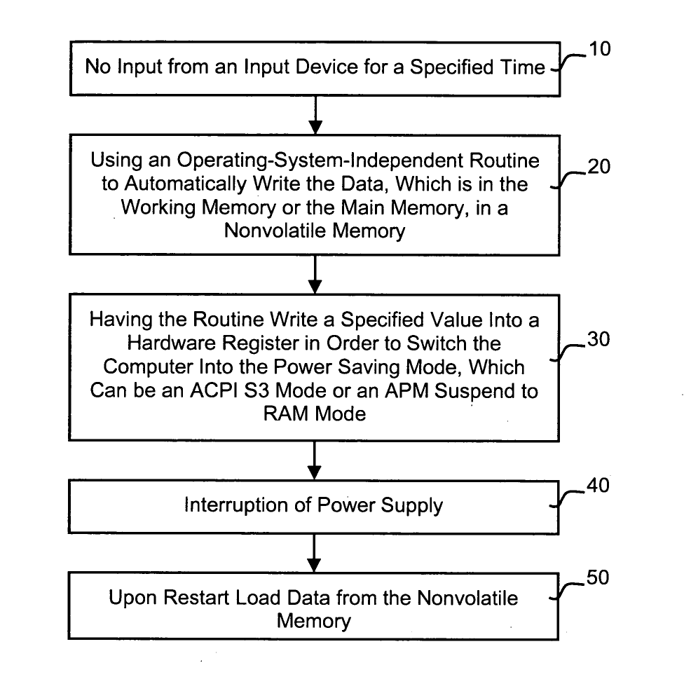

### BACKGROUND OF THE INVENTION

### FIELD OF THE INVENTION

The invention relates to a method for backing up data in the working memory of a computer in the event of an interruption of the power supply.

Nearly all PCs (Personal Computers) and notebooks available on the market are equipped with energy management so that the computer or notebook, as it may be, is automatically switched into an energy saving mode after a specified time in which there is no input performed by using an input device, such as, a keyboard or mouse.

Energy saving modes for monitors, hard disks, and even the whole computer, are known.

The screen is usually dark if the computer has been switched into an energy saving mode, either because a screen saver had been previously activated, or because the monitor's energy saving management switched the screen to dark.

If the power supply is interrupted in this energy saving mode, however, everything that is stored in the working memory, usually in the RAM (Random Access Memory) of the computer, is lost. An interruption of the power supply can be caused by a network failure or can be due to the simple fact that the user has interrupted his work for a longer period, and upon his return he powers down the computer without closing all programs beforehand as provided. With notebooks, it is more often the case that either the battery falls below its operating voltage while in the energy saving mode, or the user disconnects the notebook from the network connection by changing the location of the notebook.

When the computer is restarted again, the status prior to the cutoff cannot be regained because of the loss of RAM data, and important information or intensive modifications that were stored only in the RAM are lost beyond recovery.

Operating systems with Advanced Power Management (APM), such as Windows 95 and Windows NT have the following energy saving functions in the BIOS (Basic Input Output System) set-up:

Suspend to RAM;

Save to Disk; and

LCD (liquid Crystal Display) Off.

In suspend to RAM, all current data in the main memory, normally a DRAM (Dynamic Random Access Memory) are buffered. The data are retained as long as the computer, for example, a notebook is supplied with power. When the current supply is interrupted, i.e. without a battery or power connection, the data are lost.

The great advantage of suspend to RAM is that all data are there again in a matter of seconds with a short keystroke or mouse movement.

Save to disk means that the current data are stored on a hard disk. The hard disk requires a save to disk partition, so that data can be deposited in the save to disk area. This data is not lost when the power supply is interrupted, but it takes substantially longer for this data to become available when the computer, for example a notebook, is reactivated.

The energy saving function LCD off is an energy saving function related to the LCD or monitor, so that the whole computer runs and the data remain in RAM.

### SUMMARY OF THE INVENTION

It is accordingly an object of the invention to provide a method for backing up data in the working memory of a computer given an interruption of the power supply, which overcomes the above-mentioned disadvantages of the prior art methods of this general type.

With the foregoing and other objects in view there is provided, in accordance with the invention, a method for backing up data stored in a working memory of a computer given an interruption of a power supply of the computer. The method includes, whenever the computer will be switched into a power saving mode, automatically storing data, which is in the working memory, into a non-volatile memory.

The object of the invention is thus inventively achieved by automatically writing the data, which is in the working memory, into a non-volatile memory whenever the computer is switched into a power saving mode.

By depositing the data into a non-volatile memory, they are also available after the interruption of the power supply.

At the same time, the data remain stored in the working memory, to preserve the advantage that a restart from the power saving mode takes only seconds.

In accordance with an added feature of the invention, the power saving mode is an ACPI S3 mode (Advanced Configuration and Power Interface S3), i.e. a power saving mode according to the advanced power management setting suspend to RAM, in which all data are stored in the main memory, i.e. the working memory, of the computer.

In accordance with an additional feature of the invention, an operation-system-independent routine, which writes the data from the working memory into a non-volatile working memory, is started with the changeover into power saving mode. This function is independent of the operating system and can be implemented in, or activated by, the BIOS.

In accordance with another feature of the invention, the routine subsequently switches the computer into the power saving mode by writing a specified value into a hardware register.

If the power supply is interrupted when the computer is in power saving mode, the data are lost from the working memory, but when the computer is restarted, it retrieves the data from the non-volatile memory just like in the power saving mode save to disk.

The invention thus combines the advantages of suspend to DRAM and save to disk, because the data are available from the working memory within seconds upon an actuation of a key or mouse, but they are not lost if the power supply is interrupted, because they are automatically deposited in a non-volatile memory.

Other features which are considered as characteristic for the invention are set forth in the appended claims.

Although the invention is illustrated and described herein as embodied in a method for data backup, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The sole drawing FIGURE is a basic flow chart for illustrating the steps of the method.

### DESCRIPTION OF THE PREFERRED EMBODIMENTS

Referring now to the sole FIGURE of the drawing in detail, there is shown a basic flow chart for illustrating the steps of the method. First as shown in step 10, the computer has not obtained input from an input device for a specified or predetermined time. This initiates a sequence of steps that will result in the computer being placed into the power saving mode. As shown in step 20, an operating-system-independent routine automatically stores the data, which is in the working memory or in the main memory of the computer, in a non-volatile memory. The operating-system-independent routine writes that data into the non-volatile memory. As shown in step 30, after the data has been automatically stored in the non-volatile memory, the computer is switched into the power saving mode by having the routine write a specified or predetermined value into a hardware register. The power saving mode can be an ACPI S3 mode or an APM (advanced-power management) suspend to RAM mode in which the data are deposited into the working memory or the main memory. As shown in step 40, the power supply is interrupted while the computer is in the power saving mode. Then as shown in step 50, upon restarting the computer, the data from the non-volatile memory is automatically loaded into the working memory or the main memory of the computer.

We claim:

1. A method for backing up data stored in a working memory of a computer given an interruption of a power supply of the computer, the method which comprises:
whenever the computer will be switched into a power saving mode, automatically storing data, which is in the working memory, into a non-volatile memory.

2. The method according to claim 1, wherein:
the power saving mode is an ACPI S3 mode or an APM suspend to RAM mode in which the data are deposited in the working memory or a main memory.

3. The method according to claim 1, which further comprises:
performing the step of automatically storing data by starting an operating-system-independent routine that writes the data from the working memory into the non-volatile memory.

4. The method according to claim 3, which further comprises:
after performing the step of automatically storing data, switching the computer into the power saving mode by having the routine write a specified value into a hardware register.

5. The method according to claim 1, which further comprises:
given that the power supply has been interrupted in the power saving mode, upon restarting the computer, automatically loading the data from the non-volatile memory.
